(19) United States
(12) Patent Application Publication
(10) Pub. No.: US 2006/0173723 A1
(43) Pub. Date: Aug. 3, 2006

(54) Scheduler

(75) Inventor: David Charles Fisher, Evergreen, CO (US)

Correspondence Address: LATHROP & GAGE LC, 2345 GRAND AVENUE, SUITE 2800, KANSAS CITY, MO, 64108, US

(73) Assignee: Raytheon Company

(21) Appl. No.: 11/045,419

(22) Filed: Jan. 28, 2005

(51) Int. Cl. G06F 9/46

(52) U.S. Cl. 705/8

(57) ABSTRACT

Provided is a method for scheduling activities. The method includes receiving an activity having a designated priority, a life span, a preferred implementation time, and a scheduling time budget. The schedule is searched to determine the availability of the preferred implementation time and amount of available execution time. The activity is inserted in the schedule if the preferred implementation time if the time is available and life span is less than or equal to available execution time. If the implementation time is unavailable or the life span is greater than the available execution time, the schedule is modified. Modification of the schedule preserves scheduled activities with equal or higher priority. The method will exit when the activity is scheduled or the elapsed scheduling time exceeds the scheduling time budget.

### FIELD

This invention relates generally to the scheduling of new activities in a schedule, and, in particular, to a system which permits insertion of new activities rated by priority without removing higher priority activities.

### BACKGROUND

Simply stated, a schedule informs a party of what activity/activities are to take place, when the activity/activities will take place, and who will perform the activity/activities. A schedule may run for an hour, day, week, month, or other interval of time. Generally, the “when” quality is a specific reference to start an activity at a specific time and/or end that activity at a later specific time.

With respect to the “what” quality, a schedule may provide very generic activity information such as sleeping, eating, building, or some other activity. The “what” quality may also provide resource information—sleeping in bed 2, eating at table 5, or building at station 4.

With respect to the “who” quality—a schedule may provide information to observers of an activity regarding who is performing the activity, or the schedule may provide direction to a party to commence with or finish an activity. Typically, a schedule will also indicate free time, as in unscheduled time, as well as the busy time, as in time currently scheduled for activities.

A schedule may be assembled by scheduling activities in the order in which they are received, or in which they logically occur. A schedule may also be assembled by prioritizing activities in descending or ascending order of preference. Where the time that an activity is to occur or might occur is important, the focus of placement may shift from simple order of preference to level of priority at a specified time.

In many real world settings there are specific demands upon schedules. For any given resources (such as an aircraft, a satellite or a computer) there may be a finite availability both in terms of how long something may occur and how much may occur. Computer speeds are continuing to increase, but for each second of time a CPU has a finite number of operations to perform. A more powerful computer CPU resource may indeed execute more operations than a less powerful CPU resource, and such an option may or may not be taken into account when forming a schedule. In another example, an aircraft or satellite may not be over a particular spot on the earth at all times, and even when over a target area, may only be able to observe, deploy, gather, or perform a finite number of activities before returning to base or passing out of range.

After a schedule has been created, it is frequently necessary to insert a new activity or activities, and modify and/or delete one or more activities that have already been scheduled. When a new activity has a desired time of performance and life-span of performance that is not otherwise occupied in the schedule, insertion is quite easy. Complications arise when one or more previously scheduled activities block some or all of the new activity's desired time and life-span. The attempt and possible success of inserting a new activity may involve a significant amount of schedule alteration. How such alteration is performed may vary widely and depend on upon many factors.

To fill a schedule with activities competing for time slots, or to enter new activities into an existing schedule where the new activities compete with existing scheduled activities is far from easy. Many problems, and the algorithms that may be applied to them, are linear—double or triple the input and they will take twice or three times as long to complete. Others may be quadratic, cubic or another polynomial. When a class of problems is encountered where the solution is not polynomial, it may well be a nondeterministic polynomial—more commonly referred to as “NP-hard”.

Filling a schedule and inserting new activities into a schedule are activities that qualify as NP-hard. NP-hard problems are well known and frequently encountered, yet no algorithm to solve them is known. A fast algorithm is one that will return the best solution quickly enough for the solution to actually be useful. If the solution takes years to compute, it is quite likely that the term of usefulness will have long expired.

A famous example of such an NP-hard problem is the Traveling Salesman. A salesman desires to visit each state capitol and wants to minimize his or her driving time. Within the 50 states there are 49! possible choices —and no algorithm is known to exist that will nicely solve this problem.

For a schedule, it may be that, given an infinite amount of time, a best solution may be found. However, during the instantiation of a schedule, and the subsequent modification of a schedule, real time continues to progress. As a result, by the time a best solution has been found, it is entirely possible that too much time will have passed and the issue will be moot.

A particular schedule's purpose may also drive how activities should be scheduled and new activities added. One popular method that has been used in the assembly and modification of a schedule is the “English Auction,” also known as the first-price, open-bid auction.

In an “English Auction,” activities bid on resources. All available resources and opportunities are considered in the auction. Both lower priority activities and higher priority activities bid. Higher priority activities have higher maximum bids so they will eventually win their preferred time slots, but not before accommodating lower priority activities. Indeed, a high priority activity with a low preference for a specific time spot may be usurped, and potentially deleted by one or more lower priority activities that have a higher preference for that specific time slot.

To state it another way, a low priory activity with a high preference for a time slot may usurp a high priority activity with a low preference for the same time slot. Further, a plurality of low preference activities may combine forces and collectively usurp a high priority activity if the combined preference is greater than the solo high priority preference.

Where the desire is to schedule the maximum number of activities, regardless of priority, an English Auction may be quite effective. However, if there is a premium placed on the scheduling of higher priority activities, then an English Auction may not offer the best solution. Indeed, if the mandate is to schedule as many events as possible, but no higher priority activity may ever be usurped by one or more lower priorities, then the English Auction approach will not be acceptable.

Mixed Integer methods have also been proposed to provide schedule modification. In a Mixed Integer method, however, each and every allowable possible permutation of activities is considered and evaluated. Even with the speed of modern computers, the focus upon trying all permutations for comparison makes Mixed Integer methods vastly impractical for all but the simplest schedules.

Hence, there is a need for an ad-hoc scheduler that overcomes one or more of the technical problems found in existing scheduling systems.

### SUMMARY

This invention provides a method for scheduling activities.

In particular, and by way of example only, according to one embodiment of the present invention, a method is provided for scheduling activities, the method including the steps of: receiving an activity having a designated priority, a life span or expiration time, a preferred implementation time, and a scheduling time budget; searching the schedule to determine the availability of the preferred implementation time and amount of available execution time; inserting the activity at the preferred implementation time if the time is available and life span is less than or equal to available execution time; a method for modifying the schedule in response to the implementation time being unavailable or the life span being greater than the available execution time, the method preserving scheduled activities with equal or higher priority; and exiting the method when the elapsed scheduling time exceeds the scheduling time budget.

### BRIEF DESCRIPTION OF THE DRAWINGS

FIG. 1 illustrates a high level block diagram of a scheduling system in accordance with an embodiment;

FIG. 2 illustrates a high level flow diagram according in accordance with an embodiment;

FIG. 3 is an example schedule receiving a new activity in accordance with an embodiment;

FIG. 4 is a flow diagram describing the schedule modification of FIG. 3 in accordance with an embodiment;

FIG. 5 is another example schedule receiving a new activity in accordance with an embodiment;

FIG. 6 is a further example of the FIG. 5 schedule undergoing modification in accordance with one or more embodiments;

FIG. 7 is a flow diagram describing the schedule modification shown in FIG. 5 and FIG. 6 in accordance with one or more embodiments; and

FIG. 8 is a block diagram of a computer system in accordance with one or more embodiments.

### DETAILED DESCRIPTION

Before proceeding with the detailed description, it is to be appreciated that the present teaching is by way of example only, not by limitation. The concepts herein are not limited to use or application with a specific type of scheduler. Thus, although the instrumentalities described herein are for the convenience of explanation, shown and described with respect to exemplary embodiments, it will be appreciated that the principles herein may be applied equally in other types of scheduling systems.

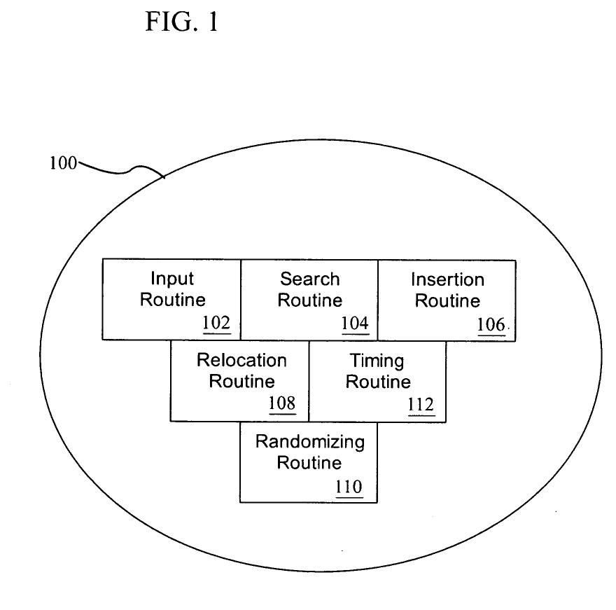

FIG. 1 is a high level block diagram of the computer program architecture of a scheduling system 100 in accordance with at least one embodiment. Scheduling system 100 may be implemented on a computer having typical computer components, such as a processor, memory, storage devices, and input and output devices. During operation, scheduling system 100 may be maintained in active memory for enhanced speed and efficiency. In addition, in at least one embodiment, scheduling system 100 may be operated on a computer network and may utilize distributed resources.

Scheduling system 100 is used to insert new activities into a schedule in accordance with the following primary, but non-exclusive, tenants: First, activities with higher priority are maintained within the schedule. No single lower priority activity or group of lower priority activaties may usurp a higher priority activity. Second, impact to the existing schedule is minimized. Existing scheduled activities are asked to reschedule. Deletion of existing lower priority activities is only performed when requests to reschedule fail to permit scheduling of the new activity. Third, if the new activity cannot be scheduled in the Scheduling Time Budget window, the scheduling system 100 will terminate.

To further assist in the following description, the following defined terms are provided.

“Priority”—A numeric priority valuation of the activity (Priority 1Activity>Priority 2 Activity).

“Life Span”—The Execution Time required for the activity, which may have a minimum value and a maximum value.

“Implementation Time”—The specific time at which the activity will commence execution.

“Scheduling Time Budget”—The amount of time allotted to attempt insertion of the activity within the schedule.

“Execution Time”—The amount of time available for execution of the activity, or the Life Span available within the schedule for the activity.

“Fluffing”—The action of increasing the scheduled activity's Life Span from a minimum value Life Span towards a maximum value Life Span, if provided.

“Cleanup”—The action of restoring a moved activity or activities back to their initial Implementation Time or as close to their initial Implementation Time as possible.

Returning to FIG. 1, scheduling system 100 includes an input routine 102, a search routine 104, an insertion routine 106, a relocation routine 108, a randomizing routine 110, and a timing routine 112. In at least one embodiment, the scheduling system 100 is operable to insert activities into a schedule that is stored as a computer data file, or multiple computer data files. The type of data file is immaterial, and may be a database, relational database, string file, or other format as is appropriate for the data and system upon which scheduling system 100 is employed.

The input routine 102 is operatively associated with an input device for permitting a user to enter an activity to be inserted into a schedule. Each activity has at least a priority, a Life Span, a preferred Implementation Time, and a Scheduling Time Budget. In certain embodiments, additional information such as, for example, specific resources may be provided as well.

The search routine 104 is operable to search a schedule to determine availability of the preferred Implementation Time, or an alternative Implementation Time, the quantity of available Execution Time, and the possible presence of a blocking activity. The insertion routine 106 inserts the activity at the determined available preferred Implementation Time, or the alternative Implementation Time when available Execution Time is equal to or greater than the Life Span.

The relocation routine 106 operates in response to the determination of a blocking activity scheduled proximate to the preferred Implementation Time or the alternative Implementation Time to relocate a blocking activity to an alternative Implementation Time. The randomizing routing 110 is operable to select an alternative Implementation Time for the activity or blocking activity. The timing routine 112 is operable to compare elapsed scheduling time to the Scheduling Time Budget and will end the program execution when elapsed scheduling time exceeds the Scheduling Time Budget.

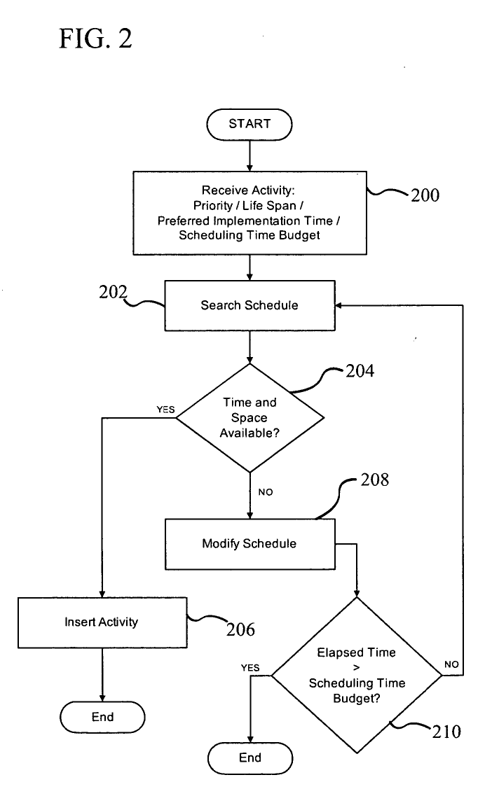

In simplest essence, scheduling system 100 may be described as an activity insertion system for a schedule. Scheduling system 100 may be employed to insert activities into an empty schedule, thus creating a new schedule, or to insert activities into a pre-existing schedule. The general operation of the schedule is illustrated in the flowchart of FIG. 2.

In at least one embodiment, scheduling system 100 receives a new activity having a priority, a Life Span, a preferred Implementation Time, and a Scheduling Time Budget, block 200. Depending on the activity, one or more of these items may be user defined.

Initially, the system searches the schedule to see if the preferred Implementation Time is available, block 202. If the Implementation Time is available and the Life Span is less than or equal to the available Execution Time (space), decision 204, the scheduling system 100 acts to insert the activity into the schedule, block 206. If the Implementation Time and space are not available, decision 204, the scheduling system 100 acts to modify the schedule, block 208.

As stated above, the process of scheduling a new activity in an existing schedule often qualifies as an NP-hard problem. Given an infinite amount of time and resources, an optimal solution can be found, however such a time frame may be significantly beyond a useful period, such as a human lifetime. Seeking a good solution is often a wiser course of action than seeking an optimal solution. In certain cases, a good solution may be simply knowing that no solution has been found and, thus, other options should be considered. By imposing the Scheduling Time Budget upon the scheduling system 100, the scheduling system 100 will advise the user of the success or failure of the user's attempt to inset an activity into the schedule.

As a result, scheduling system 100 tracks time spent in the attempt to schedule activities. Decision 210 represents the awareness of time. More specifically, scheduling system 100 will continue to seek a solution until either one is found or the Scheduling Time Budget is exceeded.

As long as the elapsed time is less than the Scheduling Time Budget, the system will attempt to modify the schedule and insert the activity. The method of modifying the schedule in response to the Implementation Time being unavailable or the Life Span being greater than the available Execution Time preserves scheduled activities with equal or higher priority. The most basic modification is to select an alternative Implementation Time for the activity, and search the schedule again, returning to block 202.

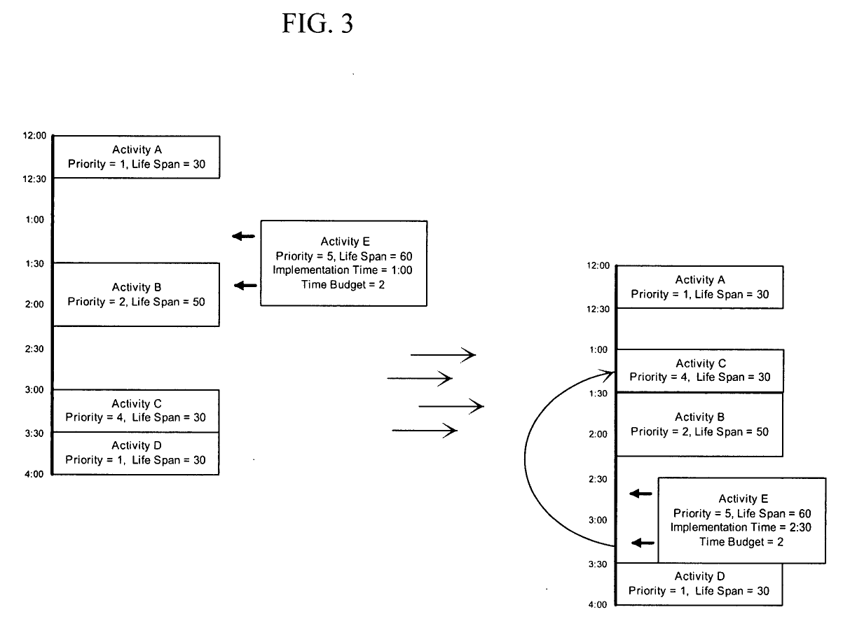

FIG. 3 presents a portion of a simple example schedule having four scheduled activities occurring from 12:00 to 4:00, Activity A—12:00, Activity B—1:30, Activity C—3:00, and Activity D—3:30. Life Span is measured in minutes. Activity E is provided as an activity to be inserted into the schedule. As shown, the Life Span of activity E is 60 minutes. The preferred Implementation Time for Activity E, is 1:00. As shown, the Execution Time currently available at 1:00 is 30 minutes, thus Activity E cannot be scheduled at 1:00 without schedule modification.

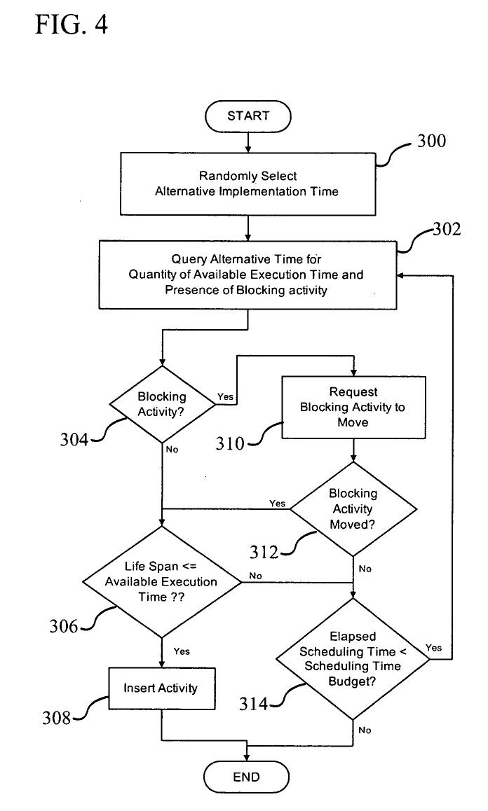

FIG. 4 illustrates in greater detail an embodiment of the method of modifying the schedule, represented as block 208 in FIG. 2, and illustrates how Activity E may be inserted. Modification commences by randomly selecting an alternative Implementation Time, block 400, for example 2:30. The schedule is then queried at the alternative Implementation Time for the quantity of available Execution Time and/or the presence of a blocking activity, block 402. As shown in FIG. 3, 2:30 has thirty minutes of available Execution Time before Activity C commences at 3:00.

It is understood that if the activity requires a resource, the availability of that resource will be an added factor in determining the acceptability of the alternative Implementation Time. In other words, if the activity to be scheduled is observing the moon with a camera for a twenty-minute exposure, alternative time periods when the moon cannot be observed or the camera is unavailable will not be selected even if twenty minutes of Execution Time are available.

If no blocking activity is present, decision 404, and the activity Life Span is less than or equal to the available Execution Time, decision 406, the scheduling system 100 will insert the activity, block 408 and end. If a blocking activity is present, decision 404, the blocking activity is requested to move, block 410. The request to move is a recursive action. More specifically, the scheduling system treats the blocking activity as a new activity to be scheduled and selects an alternative Implementation Time. Multiple instantiations of the schedule modification process may be occurring substantially simultaneously as the scheduling system 100 works to find an acceptable solution.

Activity C is a blocking activity for Activity E. In the example shown, Activity C also has a lower priority than the priority of Activity E. Scheduled activities with equal or higher priority are to be preserved within the schedule. In at least one embodiment, this preservation mandates that existing activities with equal or higher priority will not be moved. In at least one alternative embodiment, scheduled activities with equal or higher priority may be moved, but cannot be deleted.

Activity C is a blocking activity and therefore is presented to the system as a new activity to be scheduled. An alternative Implementation Time is selected, for example 1:00 and the schedule is searched to determine availability. As 1:00 is available and provides thirty minutes of Execution Time, Activity C may be moved to 1:00. As the blocking activity moved (Activity C), decision 312, and available Execution Time is now equal to the Life Span, block 306, Activity E may be inserted at 2:30, block 308.

Had the blocking activity not moved, decision 312, the elapsed scheduling time would be checked against the scheduling budget time before trying again, block 314. A blocking activity may not have moved because, for example, a suitable alternative Implementation Time was not available. In this example the process will continue until an Activity E is successfully added or the elapsed scheduling time exceeds the Scheduling Time Budget.

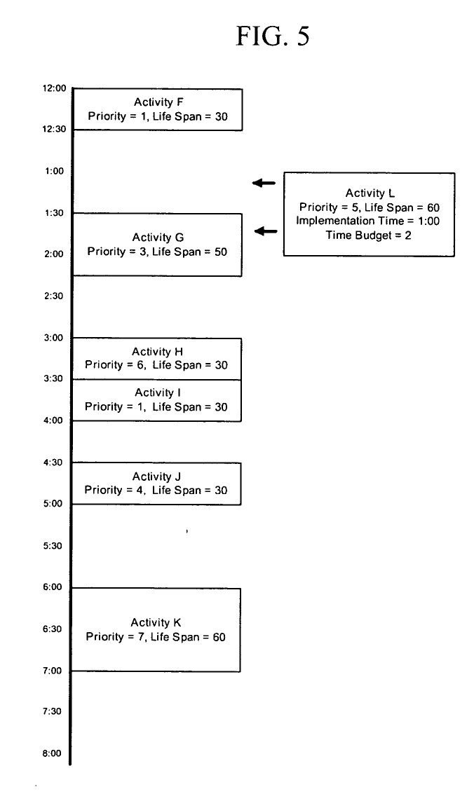

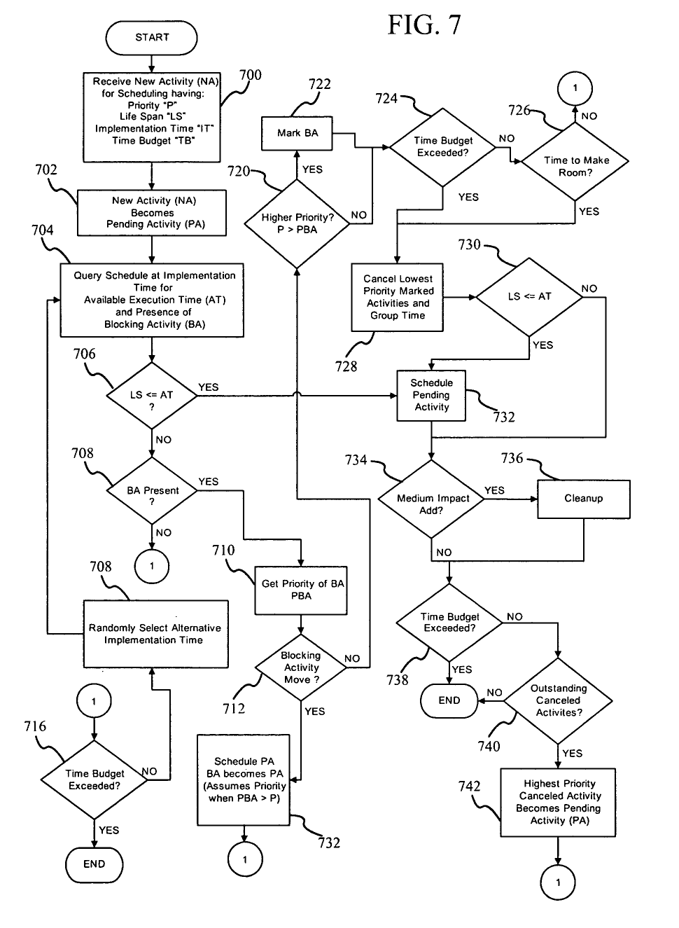

The sample schedule of FIGS. 5˜6 and the flowchart of FIG. 7 now further illustrate how scheduled activities with equal or higher priority are preserved within the schedule. As shown in FIG. 5 there are Activities E through K scheduled. Activity L is to be inserted. Again, for purposes of ease in discussion and illustration, additional factors such as resources are not shown, but may certainly be included.

With respect to the flowchart of FIG. 7 and FIG. 5, Activity L is received at block 700 as a New Activity having a Priority=5, a Life Span=60, an Implementation Time=1:00, and a Time Budget=2. In block 702, Activity L becomes the Pending Activity. In block 704, the schedule is queried at the Implementation Time for Available Execution Time and the presence of a Blocking Activity.

As shown in FIG. 5, Schedule Time 1:00 provides thirty minutes of Available Execution Time before Activity G is scheduled to commence. Thus, Life Span is greater than Available Time, decision 706, and Blocking Activity is present, decision 708. The priority of the Blocking Activity (Activity G, Priority=3), is obtained as shown in block 710.

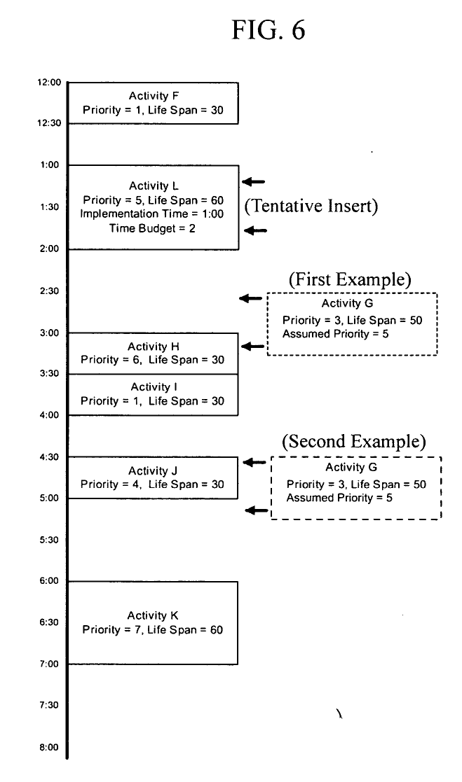

The attempt is made to move Blocking Activity G, decision 712. To accomplish this attempt, Pending Activity L is tentatively scheduled at 1:00 and Blocking Activity G becomes a new Pending Activity in a new instantiation of the scheduling system, see FIG. 6. In at least one embodiment, the tentative scheduling is accomplished by recording the particulars of Activity L to a tentative log record, such as a database. Containing information for tentatively scheduled activities, the tentative log record is more easily reviewed than the entire schedule and may be quickly searched and reviewed to confirm or deny the tentative activities.

In at least one embodiment, a file is also maintained of the particulars of each and every moved blocking activity. As with the tentative log record, the moved blocking activity record may be maintained as a database. Most specifically, in at least one embodiment, the moved blocking activity record provides a record of the original Implementation Time for each blocking activity moved in the attempt to schedule a pending activity.

In at least one alternative embodiment, the moved blocking activity record and the tentative log record may be a combined file. In an alternative embodiment, such as, for example, where the schedule is maintained as a relational database, the moved blocking activity record and tentative log record may be associated relational database elements.

It is important to note that, in this recursive scheduling attempt, Pending Activity G will assume the lower priority of Activity L. More specifically, for the rescheduling move attempt of Activity G, Activity G assumes a Priority=5, again see FIG. 6.

With respect to the flowchart of FIG. 7, a check of the elapsed time against the Time Budget is performed in decision 716, and time permitting an Alternative Implementation Time is selected as shown in block 718 as the system returns to the query operation in block 704. For the sake of a First Example, the Alternative Implementation Time for Activity G is 2:30. As shown in FIG. 6, schedule time 2:30 provides thirty minutes of Available Execution Time before Activity H is scheduled to commence. Activity H is therefore a Blocking Activity.

In this instance, and for the sake of example, Activity H cannot move, decision 712. The priorities of Pending Activity G and Blocking Activity H are compared, decision 720. As the priority of Blocking Activity H is less (6<5), Blocking Activity H is marked, block 722.

As with the tentative log record and moved blocking activity record, in at least one embodiment, a marked activity record is maintained. This marked activity record may be maintained as a separate file, an associated file (i.e. in a relational database), or as part of the part of the scheduling database. The purpose of the marked file record is to provide a easily searchable listing of marked files for subsequent use, as will be further explained below.

The issue of priority and how it is preserved in the schedule is best described by considering an alternative example for a moment. In an alternative Second Example, the Alternative Implementation Time selected in block 718 is 4:30. As shown in FIG. 6, Activity J is scheduled to commence at 4:30. Activity J is therefore a Blocking Activity.

In this instance, and for the sake of example, Activity J cannot move, decision 712. The priorities of Pending Activity G and Blocking Activity J are compared, decision 720. As the priority of Blocking Activity J is greater (4>5), Blocking Activity J is not marked.

In some instances, simply moving activities to alternative Implementation Times will not result in a scheduling solution within the Scheduling Time Budget provided. In those instances, if the activity provided by the user is to be scheduled, one or more currently scheduled activities must be deleted.

The purpose of marking lower priority activities is to ensure that higher priority activities are preserved within the schedule. A higher priority activity will assume the priority of a lower priority activity when attempting to move so as to ensure that a lower priority activity does not indirectly delete a higher priority activity. Marked activities are noted as activities that may be deleted if necessary.

More specifically, in the First Example above Activity G encountered Blocking Activity H and, as Activity G's assumed priority of 5 was greater than Activity H's priority of 6, Activity H was marked. In the Second Example above, Activity G encountered Blocking Activity J. Here the Activity′ G's assumed priority of 5 was less than the Activity J's priority of 4, and Activity J was not marked. Had Activity G not assumed the priority from Activity L, Activity G's initial priority of 3 would have been evaluated as greater than the priority of Activity J, and Activity J would have been marked. As each evaluation of priority is a one-to-one comparison, no combination of lower priority activities may usurp one or more higher priority activities.

When the user-provided activity is scheduled, any assumed priorities are dropped and initial priorities restored. In the event that the user-provided activity does not schedule within the Scheduling Time Budget, any assumed priorities are also dropped and initial priorities restored.

Returning to the flowchart of FIG. 7, following the marking or non-marking of the blocking activity, the time budget is evaluated again, decision 724. In at least one embodiment, if the scheduling system 100 has been unable to insert the user-provided activity after a percentage of the Scheduling Time Budget has elapsed, (decision 726) the scheduling system 100 will move to cancel the lowest priority marked activity(ies), block 728. In other words, the Scheduling Time Budget is divided into at least two portions, lower priority blocking activates being marked when encountered in the first portion, and marked lower priority activities being deleted in the second portion. The released time is grouped as new Execution Time, available in the schedule.

In at least one embodiment, the percentage of the Scheduling Time Budget to elapse before deleting activities is a user-provided value. In at least one alternative embodiment, the percentage of the Scheduling Time Budget is system-defined. In yet another embodiment, the system will utilize the entire Scheduling Time Budget before deleting activities.

While this may seem at odds with the user's specification of a Scheduling Time Budget, it is understood and realized that the user's perception of time for the process of deleting activities is nearly negligible to the user's perception of time in searching for opportunities. For example, ten minutes may be specified as the Scheduling Time Budget and the scheduling system 100 may search a schedule for the entire ten minutes before, in less than one second, deleting several marked activities and inserting the user-provided activity.

With the marked activities deleted, such as Activity H from Example One above, the Life Span is evaluated against the now available Execution Time, decision 730. If the Life Span is less than or equal to the Execution Time, the activity will Schedule, block 732.

Whether the user-provided activity schedules or not, in at least one embodiment there are two courses of action that may be taken before the scheduling system 100 terminates the operation. In one instance, the user may provide the new activity to the scheduling system as a High Impact Add operation. In a High Impact Add operation, scheduling system 100 will compare, mark, move and delete blocking activities as necessary in the attempt to insert the user-provided activity. Moreover, the above described process is in at least one embodiment a High Impact Add operation.

In another instance, the user may provide the new activity to the scheduling system 100 as a Medium Impact Add operation. If the scheduling system is operating upon the user-provided activity as a Medium Impact Add operation, block 734, in addition to the comparing, marking, moving and deleting blocking activities, the scheduling system 100 will also Cleanup. Moreover, the above described process when augmented by a Cleanup operation is a Medium Impact Add operation.

When operating to Cleanup, the scheduling system 100 will place activities back to their original Implementation Time in reverse order of their movement. If the user-provided activity was not successfully scheduled, the Cleanup operation will generally be entirely successful, unless, of course, the passage of time during the scheduling attempt has advanced into a time period for an activity that should have commenced had it not been rescheduled.

It is to be understood that the scheduling system 100 is a recursive system and may have multiple instantiations running substantially concurrently. In computing, multitasking is a method by which multiple tasks, also known as processes, share common processing resources such as the CPU. At any point in time only one task is actually said to be running, meaning that the CPU is actually executing instructions for that task. Multitasking solves the problem by scheduling which task may be the one running at any given time, and when another waiting task gets a turn. The act of reassigning a CPU from one task to another one is called a context switch. When context switches occur frequently enough, the illusion of concurrency in operation is achieved, as each process is incrementally advanced.

Scheduling system 100 may be executed as a multitasking operation. When a blocking activity is encountered, the scheduling system 100 may commence one operation process for the purpose of attempting to move the blocking activity. At substantially the same time, the scheduling system 100 may commence a second operation process to randomly select yet another alternative Implementation Time for the pending activity. When operating with concurrent processes, the success of one process will end the entire operation. Likewise, if the Scheduling Time Budget is exceeded, all processes will be terminated. Different operating systems provide different mechanism's for managing awareness of concurrent processes. In at least one environment, such concurrent management is achieved by signal flags set in the computer system CMOS.

If the user-provided activity was successfully scheduled, the Cleanup operation will not be entirely successful if at least one blocking activity was encountered and moved. As alternative Implementation Times are selected at random, it is possible that blocking activities may be encountered and rescheduled before an alternative randomly selected Implementation Time provides a different solution that would not have required the relocation effort. In those instances, the Cleanup operation will restore the moved blocking activities to as close as possible to their initial Implementation Time. The Cleanup operation is facilitated by the records of the moved blocking activities and tentative log described above.

In at least one embodiment, if the Scheduling Time Budget has not been exhausted, decision 738, the system will evaluate the existence of any canceled activities, decision 740. If canceled activities exist, the scheduling system 100 will utilize the remaining Scheduling Time Budget in an effort to reschedule these activities as new pending activities, block 742.

In at least one embodiment, activities in the schedule have a Life Span that further includes a Minimum Life Duration and a Maximum Life Duration. As activities are scheduled, they are inserted for their Minimum Life Duration. In other words, any and all evaluations of Life Span to Available Execution Time are based upon the Minimum Life Duration. Following the successful insertion of an activity, the scheduling system may perform an optional Fluffing operation.

When Fluffing, the scheduling system 100 reevaluates each scheduled activity to see if additional Execution Time is available at the scheduled Implementation Time such that the scheduled Life Span may be increased from the Minimum Life Duration value towards the Maximum Life Duration value.

It is understood and appreciated that the described process need not be performed in the order described, but rather the above described order is an example of at least one embodiment. Further, as performed in a computer environment, the process may be rendered in a variety of different forms of code and instruction as may be preferred for different computer systems and environments.

As may now be appreciated, although systems such as an English Auction may in some cases successfully schedule more activities in a schedule, for applications requiring high priority activities to be maintained, the scheduling system is highly advantageous. In addition, although scheduling is understood and appreciated to be an NP-hard activity, scheduling system 100 provides a user with the ability to advantageously attempt the insertion of a new activity and know the result of the attempt in known value of time.

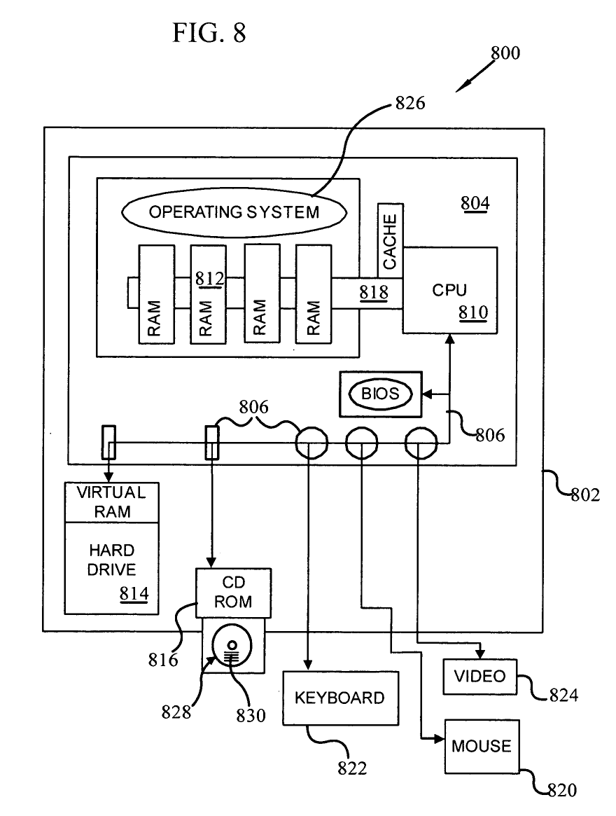

In at least one embodiment, the scheduling system 100 is implemented as a computer system for scheduling activities. FIG. 8 is a high level block diagram of an exemplary computer system 800. Computer system 800 has a case 802, enclosing a main board 804. The main board has a system bus 806, connection ports 808, a processing unit, such as Central Processing Unit (CPU) 810, and a memory storage device, such as main memory 814, hard drive 814, and CD/DVD Rom drive 816.

Memory bus 818 couples main memory 812 to CPU 810. A system bus 806 couples hard drive 814, CD/DVD Rom drive 816, and connection ports 808 to CPU 810. Multiple input devices may be provided, such as for example a mouse 820 and keyboard 822. Multiple output devices may also be provided, such as for example a video monitor 824 and a printer (not shown).

Computer system 800 may be a commercially available system, such as a desktop workstation unit provided by IBM, Dell Computers, Gateway, Apple, Sun Micro Systems, or other computer system provider. Computer system 800 may also be a networked computer system, wherein memory storage components such as hard drive 814, additional CPUs 810 and output devices such as printers are provided by physically separate computer systems commonly tied together in the network. Those skilled in the art will understand and appreciate that physical composition of components and component interconnections comprising computer system 800, and select a computer system 800 suitable for the schedules to be established and maintained.

When computer system 800 is activated, preferably an operating system 826 will load into main memory 812 as part of the boot strap startup sequence and ready the computer system 800 for operation. At the simplest level, and in the most general sense, the tasks of an operating system fall into specific categories—process management, device management (including application and user interface management) and memory management.

In such a computer system 800, the CPU 810 is operable to perform one or more of the scheduling embodiments described above. Those skilled in the art will understand that a computer-readable medium 828 on which is a computer program 830 for adding activities to a schedule may be provided to the computer system 800. The form of the medium 828 and language of the program 830 are understood to be appropriate for computer system 800. Utilizing the memory stores, such as for example one or more hard drives 814 and main system memory 812, the operable CPU 802 will read the instructions provided by the computer program 830 and operate to perform the scheduling system 100 as described above.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed is:

1. A method for scheduling activities comprising the steps of:
receiving an activity having a designated priority, a life span, a preferred implementation time, and a scheduling time budget;
searching the schedule to. determine the availability of the preferred implementation time and amount of available execution time;
inserting the activity at the preferred implementation time if the time is available and life span is less than or equal to available execution time;
a method for modifying the schedule in response to the implementation time being unavailable or the life span being greater than the available execution time, the method preserving scheduled activities with equal or higher priority; and
exiting the method when elapsed scheduling time exceeds the scheduling time budget.

2. The scheduling method of claim 1, wherein the method for modifying the schedule includes:
randomly selecting an alternative implementation time;
querying the alternative time to determine quantity of available execution time and the presence of a blocking activity;
requesting, in response to the determination of a blocking activity, the blocking activity to move to a different implementation time in the schedule and increase available execution time;
comparing the available execution time to the life span of the activity;
inserting the activity at the randomly selected alternative implementation time when the life span is less than or equal to the available execution time; and
repeating the random selection of an alternative implementation time when the available time is less than the life span until the activity is inserted or elapsed scheduling time exceeds the scheduling time budget.

3. The scheduling method of claim 1, wherein the activity further has at least one designated resource need.

4. The scheduling method of claim 1, wherein the method is stored on a computer-readable medium as a computer program which, when executed by a computer will perform the steps of scheduling activities.

5. A computer-implemented method for scheduling activities comprising the steps of:
receiving an activity having a designated priority, a life span, a preferred implementation time, and a scheduling time budget;
searching the schedule to determine the availability of the preferred implementation time and the quantity of available execution time;
inserting the activity at the preferred implementation time if the time is available and the life span is less than or equal to the available execution time;
initiating, in response to the implantation time being unavailable or the life span being greater than the available execution time, a schedule modification, the schedule modification including;
randomly selecting an alternative implementation time;
querying the alternative time to determine quantity of available execution time and the presence of a blocking activity;
requesting, in response to the determination of a blocking activity, the blocking activity to move to a different implementation time in the schedule and increase available execution time;
comparing the available execution time to the life span of the activity;
inserting the activity at the randomly selected alternative implementation time when the life span is less than or equal to the available execution time; and
repeating the random selection of an alternative implementation time when the available time is less than the life span until the activity is inserted or elapsed scheduling time exceeds the scheduling time budget.

6. The computer-implemented scheduling method of claim 5, wherein the schedule modification is recursive.

7. The computer-implemented scheduling method of claim 5, wherein scheduled activities with equal or higher priority are preserved within the schedule.

8. The computer-implemented scheduling method of claim 5, wherein the priority of the new activity is assumed by the blocking activity requested to move if the blocking activity has a greater priority, the blocking activity with assumed priority initiating a schedule modification.

9. The computer-implemented scheduling method of claim 5, wherein multiple instantiations of schedule modification occur substantially concurrently.

10. The computer-implemented scheduling method of claim 5, wherein the scheduling time budget is divided into at least two portions, and wherein lower priority blocking activities are marked when encountered in the first portion, marked lower priority blocking activities are deleted in the second portion.

11. The computer-implemented scheduling method of claim 5, wherein each blocking activity moved is remembered as to its original implementation time, each moved blocking activity being restored to its original implantation time as best as possible following insertion of the activity.

12. The computer-implemented scheduling method of claim 5, wherein each blocking activity moved is remembered as to its original implementation time, each moved blocking activity being restored to its original implantation time when elapsed scheduling time exceeds scheduling budget time.

13. The computer-implemented scheduling method of claim 5, wherein the life span includes a minimum life duration and a maximum life duration.

14. The computer-implemented scheduling method of claim 13, wherein activities are inserted for their minimum life duration.

15. The computer-implemented scheduling method of claim 13, further including fluffing activities towards maximum life duration.

16. A computer-readable medium on which is stored a computer program for adding activities to a schedule, the computer program comprising instructions which, when executed by a computer, perform the steps of:
receiving an activity having a designated priority, a life span, a preferred implementation time, and a scheduling time budget;
searching the schedule to determine the availability of the preferred implementation time and the quantity of available execution time;
inserting the activity at the preferred implementation time if the time is available and the life span is less than or equal to the available execution time;
initiating, in response to the implantation time being unavailable or the life span being greater than the available execution time, a schedule modification, the schedule modification including;
randomly selecting an alternative implementation time;
querying the alternative time to determine quantity of available execution time and the presence of a blocking activity;
requesting, in response to the determination of a blocking activity, the blocking activity to move to a different implementation time in the schedule and increase available execution time;
comparing the available execution time to the life span of the activity;
inserting the activity at the randomly selected alternative implementation time when the life span is less than or equal to the available execution time; and
repeating the random selection of an alternative implementation time when the available time is less than the life span until the activity is inserted or elapsed scheduling time exceeds the scheduling time budget.

17. The computer-readable medium of claim 16, wherein the schedule modification is recursive.

18. The computer-readable medium of claim 16, wherein scheduled activities with equal or higher priority are preserved within the schedule.

19. The computer-readable medium of claim 16, wherein the priority of the new activity is assumed by the blocking activity requested to move if the blocking activity has a greater priority, the blocking activity with assumed priority initiating a schedule modification.

20. The computer-readable medium of claim 16, wherein multiple instantiations of schedule modification occur substantially concurrently.

21. The computer-readable medium of claim 16, wherein the scheduling time budget is divided into at least two portions, and wherein lower priority blocking activities are marked when encountered in the first portion, marked lower priority blocking activities are deleted in the second portion.

22. The computer-readable medium of claim 16, wherein each blocking activity moved is remembered as to its original implementation time, each moved blocking activity being restored to its original implantation time as best as possible following insertion of the activity.

23. The computer-readable medium of claim 16, wherein each blocking activity moved is remembered as to its original implementation time, each moved blocking activity being restored to its original implantation time when elapsed scheduling time exceeds scheduling budget time.

24. The computer-readable medium of claim 16, wherein the life span includes a minimum life duration and a maximum life duration.

25. The computer-readable medium of claim 24, wherein activities are inserted for their minimum life duration.

26. The computer-readable medium of claim 24, further including fluffing activities towards maximum life duration.

27. A computer system for scheduling activities comprising:
a processing unit;
a memory storage device coupled to the processing unit;
an input device coupled to the processing unit;
an output device coupled to the processing unit;
the processing unit being operative to:
receiving an activity having a designated priority, a life span, a preferred implementation time, and a scheduling time budget;
searching the schedule to determine the availability of the preferred implementation time and the quantity of available execution time;
inserting the activity at the preferred implementation time if the time is available and the life span is less than or equal to the available execution time;
initiating, in response to the implantation time being unavailable or the life span being greater than the available execution time, a schedule modification, the schedule modification including;
randomly selecting an alternative implementation time;
querying the alternative time to determine quantity of available execution time and the presence of a blocking activity;
requesting, in response to the determination of a blocking activity, the blocking activity to move to a different implementation time in the schedule and increase available execution time;
comparing the available execution time to the life span of the activity;
inserting the activity at the randomly selected alternative implementation time when the life span is less than or equal to the available execution time; and
repeating the random selection of an alternative implementation time when the available time is less than the life span until the activity is inserted or elapsed scheduling time exceeds the scheduling time budget.

28. The computer system of claim 27, wherein the schedule modification is recursive.

29. The computer system of claim 27, wherein scheduled activities with equal or higher priority are preserved within the schedule.

30. The computer system of claim 27, wherein the priority of the new activity is assumed by the blocking activity requested to move if the blocking activity has a greater priority, the blocking activity with assumed priority initiating a schedule modification.

31. The computer system of claim 27, wherein multiple instantiations of schedule modification occur substantially concurrently.

32. A computer-readable medium on which is stored a computer program for adding activities to a schedule, the computer program comprising:
an input routine operatively associated with an input device for permitting a user to enter an activity, the user specifying a priority, a life span, a preferred implementation time, and a scheduling time budget for the activity;
a search routine for searching a schedule file to determine availability of the preferred implementation time or an alternative implementation time, the quantity of available execution time, and the possible presence of a blocking activity;
an insertion routine to insert the activity at the determined available preferred implementation time or the alternative implementation time when available execution time is equal to or greater than the life span;
a relocation routine operating in response to the determination of a blocking activity scheduled proximate to the preferred implementation time or the alternative implementation time to relocate a blocking activity to an alternative implementation time;
a randomizing routine for selecting an alternative implementation time for the activity or a blocking activity, the randomizing routine invoked by the relocation routine;
a timing routine for comparing elapsed scheduling time to the scheduling time budget and ending the program execution when elapsed scheduling time exceeds the scheduling time budget.

33. The computer-readable medium of claim 32, wherein the program is recursive.

34. The computer-readable medium of claim 32, wherein multiple instantiations of the routines execute substantially concurrently.

35. The computer-readable medium of claim 32, wherein scheduled activities with equal or higher priority are preserved within the schedule.

36. The computer-readable medium of claim 32, further including a deletion routine operating to delete a lower priority blocking activity scheduled proximate to a preferred implementation time or an alternative implementation time.

37. The computer-readable medium of claim 32, further including a tracking routine to track the original implementation time of each relocated activity; and a cleanup routine operating to restore each relocated activity to approximately each original implementation time.
